(19) United States
(12) Patent Application Publication
(10) Pub. No.: US 2020/0150249 A1
(43) Pub. Date: May 14, 2020

(54) LIDAR SENSOR WITH ATTENUATING ELEMENT

(71) Applicant: Continental Automotive Systems, Inc., Auburn Hills, MI (US)

(72) Inventors: Heiko Leppin, Hergensweiler (DE); Nehemia Terefe, Santa Barbara, CA (US)

(73) Assignee: Continental Automotive Systems, Inc., Auburn Hills, MI (US)

(21) Appl. No.: 16/185,760

(22) Filed: Nov. 9, 2018

(51) Int. Cl. G01S 7/486; G01S 17/10

(52) U.S. Cl. CPC G01S 7/4868; G01S 17/10; G01S 7/4863

(57) ABSTRACT

A lidar sensor assembly includes a light source to generate light. An optic is in optical communication with the light source to generate a field of illumination of the light. A focal plane array is configured to receive light reflected off one or more objects. The lidar sensor assembly also includes an attenuating element configured to selectively attenuate at least a portion of the light.

### TECHNICAL FIELD

The technical field relates generally to lidar sensors and particularly to flash lidar sensors.

### BACKGROUND

Flash lidar sensors generate a pulse of light, typically with a laser. The light may reflect off one or more objects and be sensed by a plurality of light sensitive detectors (e.g., an array of photodetectors), typically referred to as a focal plane array. By using the position of the photodetectors that are illuminated and the elapsed time since the pulse of light was generated, it is possible to determine dimensions and distance information of the one or more objects.

One difficulty is that when one or more detectors are subject to a very strong light return, crosstalk may occur due to internal electrical effects of the focal plane array. This crosstalk may affect neighboring detectors, and their associated pixels, by blinding them in a way that signals of lower intensity may be overlooked.

As such, it is desirable to present a sensor assembly and method in which such crosstalk is reduced or eliminated. In addition, other desirable features and characteristics will become apparent from the subsequent summary and detailed description, and the appended claims, taken in conjunction with the accompanying drawings and this background.

### BRIEF SUMMARY

In one exemplary embodiment a lidar sensor assembly includes a light source to generate light. An optic is in optical communication with the light source to generate a field of illumination of the light. A focal plane array is configured to receive light reflected off one or more objects. The lidar sensor assembly also includes an attenuating element configured to selectively attenuate at least a portion of the light.

In one exemplary embodiment a method of operating a lidar sensor assembly includes generating light with a light source. The method also includes generating a field of illumination of the light with an optic in optical communication with the light source. The method further includes receiving light reflected off one or more objects with a focal plane array configured. The method also includes selectively attenuating at least a portion of the light with an attenuating element.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a block diagram of a lidar sensor assembly with a liquid crystal display implemented as an attenuator according to one exemplary embodiment;

FIG. 2 is a cross-sectional diagram of a light transmission path of the lidar sensor assembly with the liquid crystal display implemented as the attenuator according to one exemplary embodiment;

FIG. 3 is a graphical representation of pixels corresponding to photodetectors according to one exemplary embodiment;

FIG. 4 is a block diagram of a lidar sensor assembly with a digital mirror device implemented as the attenuator according to one exemplary embodiment; and

FIG. 5 is a flow chart of a method of operating the lidar sensor assembly with the attenuator according to one exemplary embodiment.

### DETAILED DESCRIPTION

Referring to the Figures, wherein like numerals indicate like parts throughout the several views, a lidar sensor assembly 100 is shown and described herein. As appreciated by those skilled in the art, the term “lidar” is an abbreviation for “light detection and ranging”. The term is often used interchangeably with “ladar” by those skilled in the art.

The lidar sensor assembly 100 includes a light source 102 to generate light. In the exemplary embodiments, the light source 102 is a laser (not separately numbered). The laser of the exemplary embodiments is configured to generate pulses of light, i.e., a pulsed laser light output, where the laser turns “on” and “off” for predetermined lengths of time.

The laser may be a solid-state laser, monoblock laser, semiconductor laser, fiber laser, and/or an array of semiconductor lasers. It may also employ more than one individual laser. The pulsed laser light output, in the exemplary embodiment, has a wavelength in the infrared range. More particularly, the pulsed laser light output has a wavelength of about 1064 nanometers (nm). However, it should be appreciated that other wavelengths of light may be produced instead of and/or in addition to the 1064 nm light. The lidar sensor assembly 100 also includes one or more optics 104, 105, e.g., lenses, optically coupled with the light source 102. In the exemplary embodiment, a first optic 104 is a collimator or beam expander configured to transform the light source to shape light distribution.

A second optic 105 may also be utilized to further distribute the light. The second optic 105 may be implemented with a microlens array to create an array of independent sources, hence providing homogeneity and eye safety. The second optic 105 may alternatively be implemented with a macroscopic lens where homogeneity is achieved within or before the LCD.

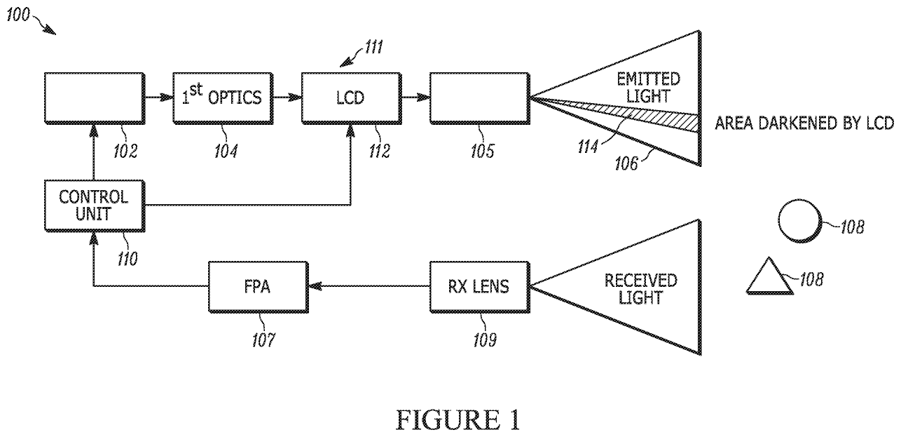

Still referring to FIG. 1, the lidar sensor assembly 100 further includes a focal plane array 107. The focal plane array 107 includes a plurality of light sensitive detectors (not separately shown). In the exemplary embodiment, the light sensitive detectors are arranged in a rectangular layout. However, it should be appreciated that other shapes and configurations of the light sensitive detectors of the focal plane array 107 may be utilized.

The light sensitive detectors of the focal plane array 107 are configured to receive light reflected off one or more objects 108. Each detector generates an electrical signal corresponding to the received reflected light, as is well known to those skilled in the art. A receiving lens 109 may be configured and disposed to receive light prior to the focal plane array 107. In the exemplary embodiment shown in FIG. 1, the receiving lens 109 is configured and disposed to focus the light on the focal plane array 107. The focal plane array 107 may then generate an image of pixels 300, as shown in FIG. 3, wherein each pixel 300 corresponds to one of the detectors.

As described above, one or more of the detectors may be illuminated by a very strong light return, as is shown in two instances on FIG. 3. Due to internal electrical effects within the focal plane array 107, this may cause “crosstalk” that affects neighboring pixels 300. This crosstalk may “blind” the neighboring pixels 300 such that reflections of a lower intensity could be overlooked in the proximity of highly illuminated pixels. Identifying the one or more detectors that are illuminated by a very strong light return may be achieved by analyzing the electrical properties generated by the light sensitive detectors of the focal plane array 107.

Referring again to FIG. 1, the lidar sensor assembly 100 may include a controller 110. The controller 110 of the exemplary embodiments is configured to perform computations and/or execute instructions (i.e., run a program). The controller 110 may include and/or be implemented as one or more microprocessors, microcontrollers, application specific integrated circuits (“ASICs”), and/or any other suitable devices. Although FIG. 1 shows a single controller 110, it should be appreciated that the controller 110 may be implemented as a plurality of separate devices.

In the exemplary embodiment, the controller 110 is in communication with the light source 102 and is configured to control operation of the light source. That is, the controller 110 commands the light source 102 as to when to illuminate, the length of such illuminations, etc. Furthermore, the light source 102 may provide data back to the controller 110.

The controller 110 of the illustrated embodiment is also in communication with the focal plane array 107. The controller 110 may include an analog-to-digital converter (“ADC”) (not shown) to convert the electrical signals from the focal plane array 107 to digital and/or numerical form, as appreciated by those skilled in the art. Image data is transmitted from the focal plane array 107 to the controller 110. Of course, other data may be transferred between the focal plane array 107 and the controller 110.

The controller 110 is configured to determine a highly illuminated area of the focal plane array 107. That is, the controller 110 may analyze the image data received from the focal plane array 107 and determine the particular pixel 300 or pixels 300 where light reflected from an object 108 exhibits a high intensity that can result in “crosstalk” between pixels 300, as shown in FIG. 3.

Still referring to FIG. 1, the lidar sensor assembly 100 also includes an attenuating element 111. The attenuating element 111 is configured to selectively attenuate at least a portion of the light to at address pixel 300 crosstalk. More particularly, the attenuating element 111 is configured to dim the light to reduce highly illuminated areas on the focal plane array 107. The LCD 112 includes a plurality of pixels (not shown) that generally correspond to the pixels 300 generated by the focal plane array 107.

In the embodiment shown in FIG. 1, the attenuating element 111 is implemented with a liquid-crystal display (“LCD”) 112. The LCD 112 is optically positioned between the light source 102 and the second optic 105. It should be appreciated that a lens or other optics may be disposed between the light source 102 and the LCD 112 to properly configure and/or focus the light generated by light source 102 through the LCD 112.

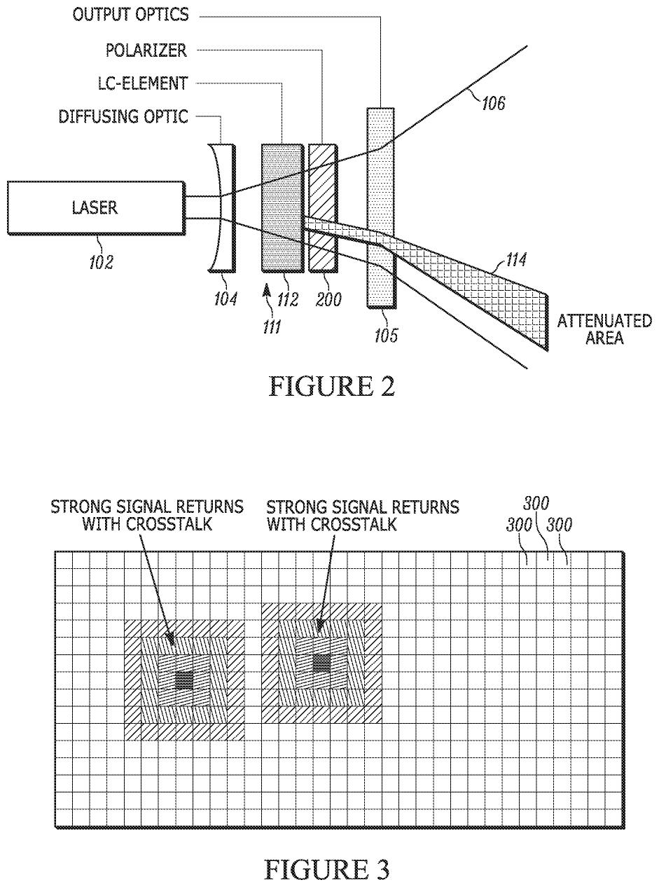

A polarizer 200, as shown in FIG. 2, may also be utilized to polarize the light. The polarizer 200 may be integral with the LCD 112.

The pixels of the LCD 112 are selectable between a generally transparent state where light may be freely transmitted therethrough, and an opaque state, where the pixels reduce or block the transmission of light.

The controller 110 is in communication with the attenuating element 111. Further, the controller 110 is configured to control the attenuating element 111 based on data received from the focal plane array 107. Particularly, the controller 110 is configured to control the attenuating element 111 to selectively attenuate at least a portion of the light corresponding to the highly illuminated area of the focal plane array 107.

For example, in response to one or more detectors of the focal plane array 107 being subject to a high level of illumination, the controller 110 may instruct corresponding pixels of the LCD 112 to darken, i.e., become opaque. This will darken a region 114 in the field of illumination 106, thus lessening the level of illumination that is reflected back to the focal plane array 107. As such, crosstalk in the focal plane array 107 is reduced and other objects 108 in the field of view, if present, may be adequately detected.

It should be appreciated that the term “high level of illumination” may refer to energy levels that would cause saturation of photo elements in the focal plane array 107 which can cause an incorrect intensity reading, e.g., the signal is out of the valid input range, and cause artifacts in other pixels of the focal plane array 107 as the pixels share common circuitry (e.g., a power supply) and crosstalk (i.e., electrical coupling) can occur.

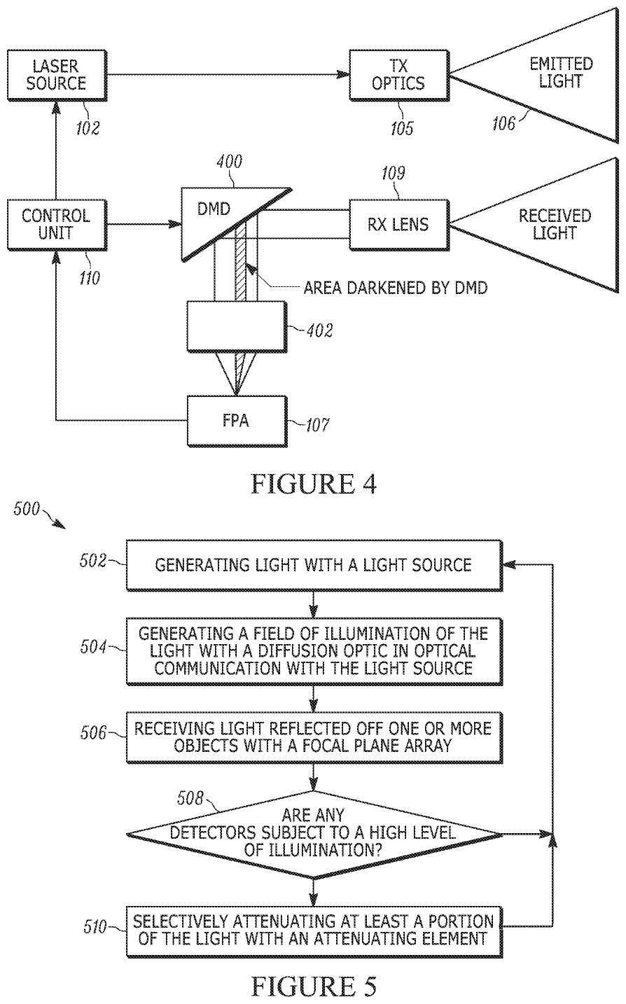

FIG. 4 illustrates an exemplary embodiment in which the attenuating element 111 is optically disposed in the receive path of light, instead of the transmit path. More specifically, the attenuating element 111 in FIG. 4 is optically disposed between the receiving lens 109 and the focal plane array 107.

In this embodiment, the attenuating element 111 is a digital mirror device (“DMD”) 400. The DMD 400 may alternately be referred to as a digital micromirror device. The DMD 400 in this embodiment is a micro-opto-electromechanical system (“MOEMS”) having a plurality of microscopic mirrors (not shown) arranged in a rectangular array. The mirrors may be individually rotated to an “on” or “off” state. That is, each mirror may direct light toward the focal plane array 107 or away from the focal plane array 107. The mirrors of the DMD 400 may correspond to the detectors (or pixels) of the focal plane array 107.

In the embodiment shown in FIG. 4, a collimator 402 is disposed between the DMD 400 and the focal plane array 107. Those skilled in the art appreciate that the collimator 402 narrows the light between the DMD 400 and the focal plane array 107.

In response to one or more detectors of the focal plane array 107 being subject to a high level of illumination, the controller 110 may instruct corresponding mirrors of the DMD 400 to not direct light towards said detectors. This will lessen the level of light that is reflected back to the focal plane array 107 when a high level of illumination exists. As such, crosstalk in the focal plane array 107 is reduced and other objects 108 in the field of view, if present, may be adequately detected.

It should be appreciated that, in other embodiments, the DMD 400 may be disposed in the transmit path, e.g., between the laser source 102 and the optics 105.

A method 500 of operating a lidar sensor assembly 100 is shown in FIG. 5. The method 500 includes, at 502, generating light with a light source 102. The method 500 continues with, at 504, generating a field of illumination 106 of the light with an optic 105 in optical communication with the light source 102. The method 500 further includes, at 506, receiving light reflected off one or more objects with a focal plane array 107.

The method 500 may also include, at 508, determining a highly illuminated area of the focal plane array 107 with a controller 110. The controller 110 then determines which, if any, of the detectors of the focal plane array 107 are being subjected to a high level of illumination. In response to one or more of the detectors being subjected to a high level of illumination, the method 500 may include, at 510 selectively attenuating at least a portion of the light with an attenuating element 111.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A lidar sensor assembly comprising:
a light source to generate light;
an optic optically coupled with said light source to generate a field of illumination of the light;
a focal plane array configured to receive light reflected off one or more objects;
an attenuating element configured to selectively attenuate at least a portion of the light; and
a controller in communication with said focal plane array and said attenuating element and configured to control said attenuating element based on data received from said focal plane array.

2. The lidar sensor assembly as set forth in claim 1, wherein said controller is configured to determine a highly illuminated area of said focal plane array.

3. The lidar sensor assembly as set forth in claim 2, wherein said controller is configured to control said attenuating element to selectively attenuate at least a portion of the light corresponding to the highly illuminated area of said focal plane array.

4. The lidar sensor assembly as set forth in claim 2, wherein said focal plane array comprises a plurality of light sensitive detectors and wherein said controller is configured to identify any of said light sensitive detectors exhibiting a very strong light return in determining a highly illuminated area of said focal plane array.

5. The lidar sensor assembly as set forth in claim 1, wherein said attenuating element is optically disposed between said light source and said optic.

6. The lidar sensor assembly as set forth in claim 5, wherein said attenuating element is a liquid crystal display.

7. The lidar sensor assembly as set forth in claim 1, further comprising a receiving lens configured to receive light reflected off the one or more objects prior to said focal plane array.

8. The lidar sensor assembly as set forth in claim 7, wherein said attenuating element is optically disposed between said receiving lens and said focal plane array.

9. The lidar sensor assembly as set forth in claim 8, wherein said attenuating element is a digital mirror device.

10. The lidar sensor assembly as set forth in claim 9, further comprising a collimator disposed between said digital mirror device and said focal plane array.

11. The lidar sensor assembly as set forth in claim 1, wherein said light source is a laser configured to generate pulses of light.

12. A method of operating a lidar sensor assembly, said method comprising:
generating light with a light source;
generating a field of illumination of the light with an optic optically coupled to the light source;
receiving light reflected off one or more objects with a focal plane array;
selectively attenuating at least a portion of the light with an attenuating element; and
controlling the attenuating element with a controller based on data received from the focal plane array.

13. The method as set forth in claim 12, further comprising determining a highly illuminated area of the focal plane array with a controller.

14. The method as set forth in claim 13, further comprising controlling the attenuating element corresponding to the highly illuminated area of the focal plane array with the controller.

15. The method as set forth in claim 13, wherein determining a highly illuminated area of the focal plane array comprises identifying any of the light sensitive detectors exhibiting a very strong light return.
